(19) United States
(12) Patent Application Publication
(10) Pub. No.: US 2024/0119433 A1
(43) Pub. Date: Apr. 11, 2024

(54) System and Method for Utilizing Casino Points to Satisfy Financial Service Fees

(71) Applicants: Diallo Gordon, Las Vegas, NV (US); Melissa Strickland, Henderson, NV (US); Jason King, Las Vegas, NV (US)

(72) Inventors: Diallo Gordon, Las Vegas, NV (US); Melissa Strickland, Henderson, NV (US); Jason King, Las Vegas, NV (US)

(21) Appl. No.: 18/377,995

(22) Filed: Oct. 9, 2023

Related U.S. Application Data
(60) Provisional application No. 63/414,174, filed on Oct. 7, 2022.

(51) Int. Cl. G06Q 20/10

(52) U.S. Cl. CPC G06Q 20/1085; G07F 17/3255

(57) ABSTRACT

A system and method for facilitating cash access for casino patrons, using casino points and casino complimentary dollars to satisfy financial service fees imposed on casino patrons via cage cashiers, mobile devices, and redemption kiosks that perform ATM functions, debit and credit transactions, check cashing, gaming wallet transactions, and crypto currency transactions for cash access.

### CROSS-REFERENCE TO RELATED APPLICATIONS

The present application takes priority from App. No. 63/414,174, filed Oct. 7, 2022, which is incorporated herein by reference.

### BACKGROUND

Casinos typically offer their patrons reward points and “comps” as an incentive to continue gaming. Those points can typically be redeemed for casino services or services offered by the casino's partner businesses, such as restaurants, hotels, or shops. The purpose of these points is to incentivize the customer to continue gaming and to use the services offered by casino partners.

When a customer needs to withdraw cash or to perform another financial transaction at a casino, they typically use a kiosk such as an ATM. To perform financial transactions at such a kiosk, the customer typically has to pay a fee. In the prior art systems, this fee has to be paid in cash. This has a disincentivizing effect on the customer, since this fee is coming directly out of their bank account.

A need exists for a more frictionless and less disincentivizing method of funding financial transactions.

### SUMMARY OF THE INVENTION

An object of the present invention is to provide a frictionless way for customers to make cash withdrawals at a casino.

Another object of the present invention is to provide a way for customers to pay ATM fees at a casino using reward points.

Another object of the present invention is to increase a casino's income.

The method of the present invention comprises using an ATM to initiate a financial transaction with a bank that involves a transaction fee; the ATM then presents the customer with a choice of paying the transaction fee using cash or points. If the customer chooses points, the transaction fee is increased by a predetermined amount, and part of it is paid to the casino while the other part goes to the bank. The points are taken out of the customer's point balance at the casino.

The transaction could be a debit card withdrawal, a credit card withdrawal, a check cashing transaction, or a cryptocurrency transaction.

The transaction fee could be increased by a percentage or by a predetermined amount. The split between the casino and the bank could be a percentage, a percentage plus a fixed amount, or a fixed amount.

The system of the present invention comprises at least one ATM, a casino server system comprising a database that stores information regarding the customers and point balances for each one, and a bank server connected to the at least one ATM.

### LIST OF FIGURES

FIG. 1 shows a flowchart of an embodiment of the method of the present invention.

FIG. 2 shows a flowchart of an embodiment of the method of the present invention.

FIG. 3 shows a flowchart of an embodiment of the method of the present invention.

FIG. 4 shows a flowchart of an embodiment of the method of the present invention.

FIG. 5 shows a flowchart of an embodiment of the method of the present invention.

FIG. 6 shows an embodiment of the system of the present invention.

### DETAILED DESCRIPTION

For all the embodiments of the system, the key distinction of the invention from the prior art is that points or comps are used to pay transaction fees for financial transactions. The advantage of this is that it encourages the customer to make more financial transactions, increases revenue for the casino, and benefits the bank by encouraging more financial transactions and fees.

For purposes of the present disclosure, points are any reward units given by a casino or other gaming business. Typically, a casino grants points based on “coin in” or “chip in”—namely, for every dollar spent at a casino, the customer is awarded either one point or a fraction of a point. Most casinos give one point for one dollar, or at minimum 10%, though other exchange amounts are also possible and not excluded from the present disclosure.

For purposes of the present disclosure, comps are free items and services given to a customer as a reward for gaming. Typically, comps are given to the customer as a coupon that can be used at the casino itself or for related items and services. Most usually, the amount of comps is also calculated based on “coin in” or “chip in”, and is based on the theoretical probability loss that is inherent to each game—for example, if a slot machine has a hold of 5%, it means that for every dollar spent, the casino will hold on to $0.05. Thus, if a player gambles $100, they will receive $5 in comps. While this is the typical method of calculating comps, other amounts and other calculation methods are not excluded from the present disclosure.

Other reward units may be used for the present invention as well. For example, some casinos grant resort points or resort credits, which are calculated based on customer spend (i.e. spending on food and beverage, hotel stay, spa, etc.) These are variable, but most often, 1 resort point/credit is given for $1 spent. Other calculation methods or exchange rates are not excluded from the present disclosure.

More broadly, the system of the present invention encompasses any reward points given by a casino to a customer.

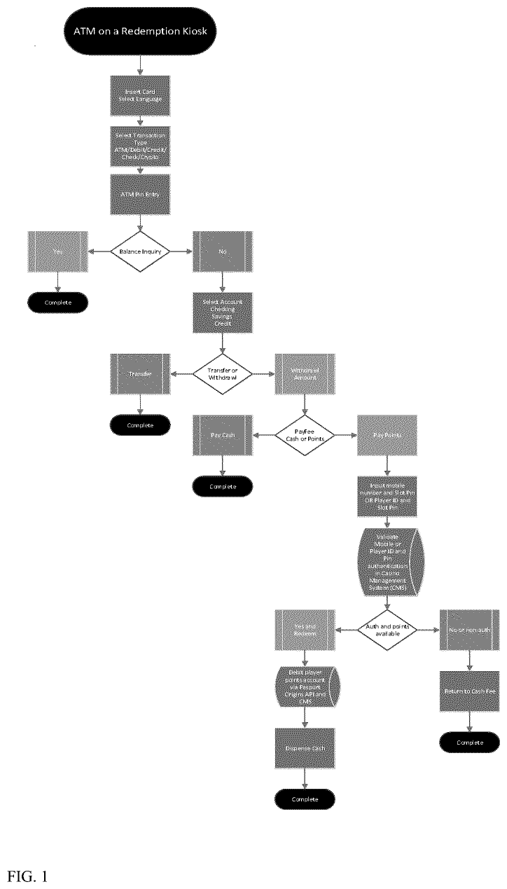

FIG. 1 shows a flowchart of an embodiment of the method of the present invention for use in an ATM transaction. A customer initiates an ATM transaction using their debit card. At that point, the customer is offered the choice to use cash for the transaction fee or to use their points. If the customer chooses cash, they complete the transaction and pay the appropriate fee. If the customer chooses points/comps, the fee is increased by $2 and the casino receives a commission, plus $0.25. The remainder of the fee is split between the bank and the technology service provider, and the customer completes the transaction.

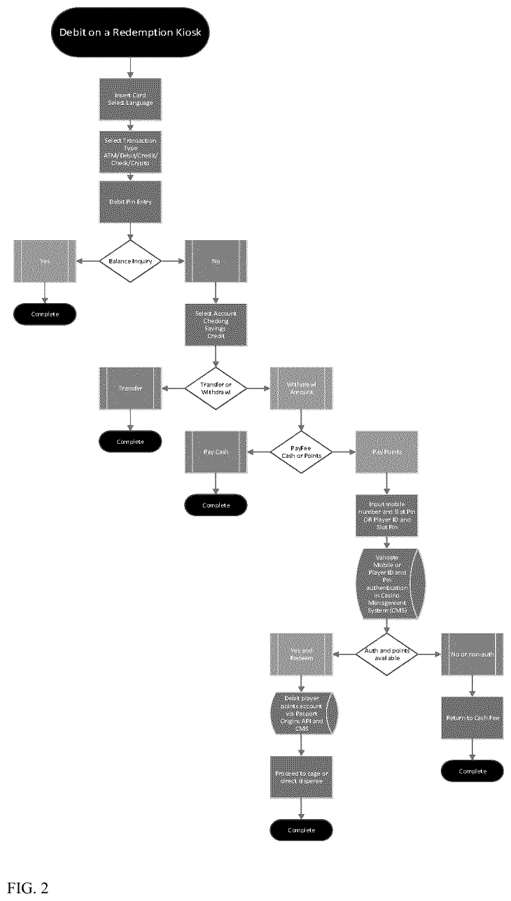

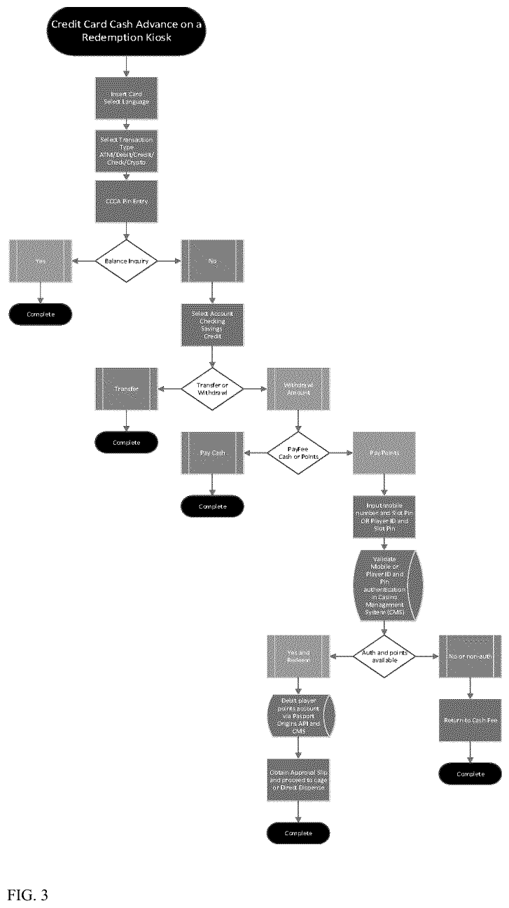

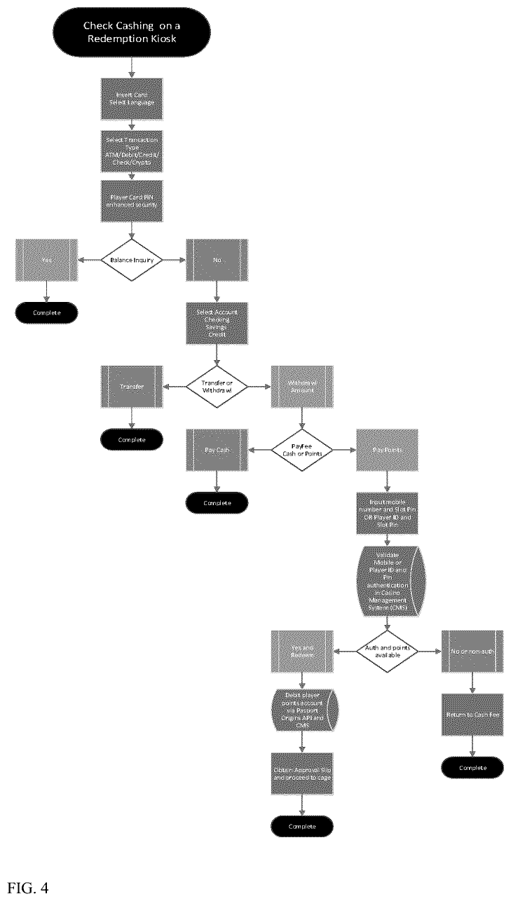

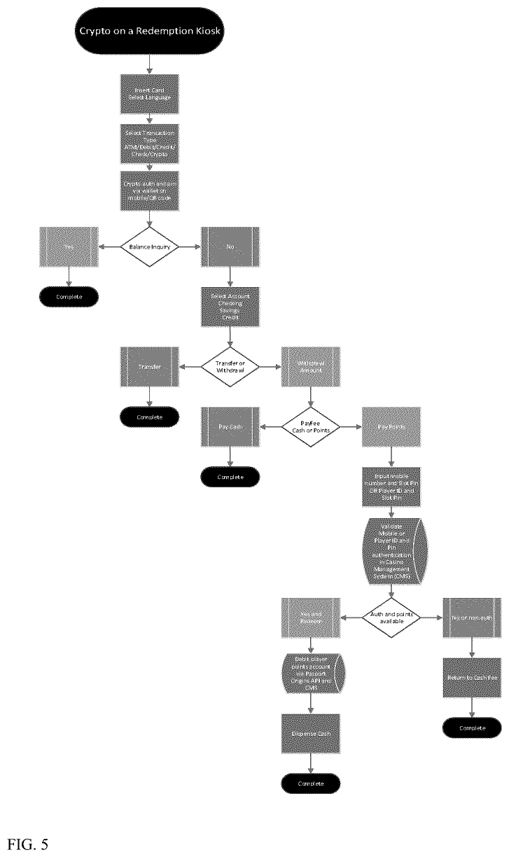

FIG. 2 shows the same process used for a debit card transaction; FIG. 3 shows the same process used for a credit card transaction; FIG. 4 shows the same process used for a check cashing transaction; FIG. 5 shows the same process used for a crypto currency transaction. It is to be understood that these Figures show embodiments of the method of the present invention and are not meant to be limiting.

The advantage of the present invention is that customers frequently hesitate to use ATM's for cash withdrawal or other financial transactions because of the high fees involved. Because these transactions happen so frequently in a casino context, this hesitation can be costly to the casino insofar as it discourages further gaming. Since customers do not see casino points the same way they would see “real money,” a customer would not hesitate as much to make cash withdrawals or other financial transactions if points were used instead.

Another advantage of the present invention is that it allows the casino to benefit from the customer's financial transactions. As mentioned in the disclosure, in one of the embodiments of the invention, the fee is higher if the customer uses points than if the customer uses cash. The casino then keeps part of that higher fee.

Another advantage of the present invention is that it encourages customers to perform more financial transactions, which benefits the bank.

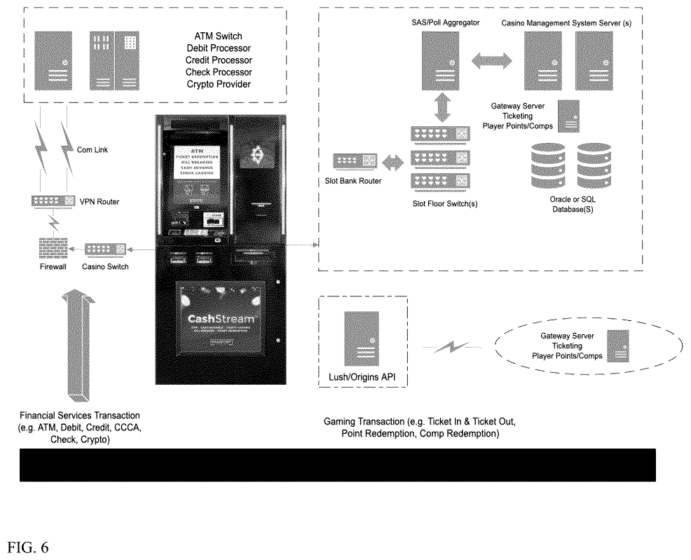

An embodiment of the system of the present invention is shown in FIG. 6. The kiosk is connected via a casino switch and VPN router to an ATM switch, debit processor, credit processor, check processor, or crypto provider. It is also connected to the casino management system server, which contains information regarding each customer's point balances, along with other information. The casino management system server is connected to the SAS/poll aggregator, which is connected to the slot floor switches and the slot bank router. The casino management system server is also connected to the gateway server.

The database stored on the gateway server preferably comprises information related to each customer's profile, play history, point balances, point expiration dates, and other variables relevant to a customer's use of points. In an embodiment, the database stores the following data for each customer:
a. First Name
b. Last Name
c. Date of Birth
d. Gender
e. Address
f. E-mail
g. Home Phone
h. Cell Phone
i. Driver's License Number
j. Unique Player ID
k. PIN
l. Interests
m. Slot statistical detail
n. Table game statistical detail
o. Resort stay detail
p. Points
q. Comps
r. Tier Level
s. Point expiry
t. Comp expiry
u. Groups

It is to be understood that the present invention does not require all of these data fields to be present in the database, and that any subset of these fields is entirely consistent with practicing the present invention, as long as the database comprises some identifier for the customer and some indication of the point balance.

The database of the present invention can be written in any language, but is preferably written in SQL or Oracle. The database and any applications used with it may reside on one server or multiple servers—for example, database servers, web servers, and network attached storage. The server or servers preferably communicates with the rest of the system through Origins API.

The kiosk of the present invention may be an ATM or may be another kiosk designed for providing automated financial transactions to a customer. As shown in the Figure, the kiosk is connected to the server that stores the database, as well as to a bank or other financial server that provides the financial information to complete the transaction.

To practice an embodiment of the present invention, a debit/ACH account is set up for each casino participating in the system. Typically, casinos have a marketing/debit account for merchandise bought with comps; this would be a separate account that would be used for bank fees.

In an embodiment of the invention, when a customer decides to use their point balance or comp balance to pay a financial services fee, the kiosk accesses the database and retrieves the customer's identifying information and point balance. The kiosk then determines whether or not the customer has enough points to pay the financial services fee. If that is true, the kiosk deducts the appropriate number of points from the customer's point balance and updates the database accordingly. The funds are then taken out of the casino's debit/ACH account and transmitted to the bank, ATM owner, or both. In an embodiment of the invention, to simplify accounting, funds are transferred only once a day for all the transactions made that day. It is to be understood that any other schedule of transfers of funds is consistent with the present invention, and that funds may be transferred weekly, monthly, or after every transaction, or at any other frequency.

Exemplary embodiments are described above. It is to be understood that any reasonable equivalents to the above embodiments are included in the present disclosure.

1. A method of managing a financial transaction for a customer at a casino through a bank, comprising:
using an ATM to initiate a financial transaction for the customer with the bank, wherein the financial transaction comprises paying a transaction fee to the bank;
using the ATM display to present the customer with a choice to use cash or points to pay the transaction fee, wherein points are rewards granted to the customer by the casino, wherein the casino maintains a point balance associated with the customer;
if the customer chooses points, performing the following steps:
increasing the transaction fee by a predetermined amount to create an increased transaction fee;
withdrawing an amount equivalent to the increased transaction fee from the customer's point balance at the casino;
transmitting a first predetermined portion of the increased transaction fee to the bank;
transmitting an amount equal to the difference between the increased transaction fee and the first predetermined portion to the casino.

2. The method of claim 1, wherein the financial transaction is a withdrawal using a debit card.

3. The method of claim 1, wherein the financial transaction is a withdrawal using a credit card.

4. The method of claim 1, wherein the financial transaction is a check cashing transaction.

5. The method of claim 1, wherein the financial transaction is a cryptocurrency transaction.

6. The method of claim 1, wherein the predetermined amount is a fixed amount that does not depend on the transaction fee.

7. The method of claim 1, wherein the predetermined amount is a percentage of the transaction fee.

8. The method of claim 1, wherein the first predetermined portion is a fixed amount that does not depend on the transaction fee.

9. The method of claim 1, wherein the first predetermined portion is a percentage of the transaction fee.

10. The method of claim 1, wherein the first predetermined portion is a percentage of the transaction fee, plus a fixed amount.

11. A system for managing a financial transaction for a customer at a casino through a bank, comprising:
at least one ATM;
a casino server system;
a casino customer database located on the casino server system, wherein the casino customer database comprises at least the following information:
customer name;
point balance;
point expiration dates;
a bank server connected to the at least one ATM;
wherein the at least one ATM is configured to perform financial transactions for a customer and to collect a transaction fee;
wherein the at least one ATM is configured to offer the customer a choice between using points for the transaction fee and using cash for the transaction fee;
wherein if the customer chooses using points for the transaction fee, the at least one ATM is configured to increase the transaction fee by a predetermined amount to result in an increased transaction fee, transmit a first predetermined portion of the increased transaction fee to the bank server, and transmit an amount equal to the difference between the increased transaction fee and the first predetermined portion to the casino.
